(19) United States
(12) Patent Application Publication
(10) Pub. No.: US 2026/0121099 A1
(43) Pub. Date: Apr. 30, 2026

(54) APPARATUS AND METHOD FOR STACKING ELECTRODE PLATES

(71) Applicant: Samsung SDI Co., Ltd., Yongin-si (KR)

(72) Inventor: Jinmun Kim, Yongin-si (KR)

(73) Assignee: Samsung SDI Co., Ltd., Yongin-si (KR)

(21) Appl. No.: 19/299,713

(22) Filed: Aug. 14, 2025

(30) Foreign Application Priority Data
Oct. 24, 2024 (KR) 10-2024-0146943

(51) Int. Cl. H01M 10/04

(52) U.S. Cl. CPC H01M 10/0404; H01M 10/0459

(57) ABSTRACT

Disclosed herein are an apparatus and method for stacking electrode plates. The apparatus for stacking the electrode plates includes an electrode plate movement unit configured to move the electrode plates, a slide unit having a sliding curved surface formed along its inner circumference and an electrode plate discharge port formed at its bottom, and configured to slide the electrode plates supplied from the electrode plate movement unit along the sliding curved surface for discharge through the electrode plate discharge port, and a stacking unit configured to sequentially stack the electrode plates discharged through the electrode plate discharge port.

### CROSS-REFERENCE TO RELATED APPLICATIONS

This present application claims priority to and the benefit under 35 U.S.C. § 119(a)-(d) of Korean Patent Application No. 10-2024-0146943, filed on Oct. 24, 2024, in the Korean Intellectual Property Office, the entire disclosure of which is incorporated herein by reference.

### FIELD

The present disclosure relates to an apparatus and method for stacking electrode plates, and more particularly, to an apparatus and method for stacking electrode plates, which allow electrode plates to be sequentially stacked by sliding through a slide unit having a sliding curved surface formed along its inner circumference.

### BACKGROUND

Unlike primary batteries that are not designed to be charged, secondary batteries are designed to be discharged and recharged. Low-capacity secondary batteries are used in small portable electronic devices, such as smart phones, feature phones, notebook computers, digital cameras, and camcorders, while large-capacity secondary batteries are widely used as power sources for driving motors, such as of hybrid vehicles or electric vehicles, and for power storage. The secondary battery includes an electrode assembly consisting of a positive electrode and a negative electrode, a case that accommodates the electrode assembly, a terminal part connected to the electrode assembly, etc.

The herein information disclosed in this Background section is for enhancement of understanding of the background of the present disclosure, and therefore, it may contain information that does not constitute related (or prior) art.

### SUMMARY

Accordingly, an object of the present disclosure is to provide an apparatus and method for stacking electrode plates, which allow the electrode plates to be sequentially stacked by sliding through a slide unit having a sliding curved surface formed along its inner circumference.

However, the technical problem to be solved by the present disclosure is not limited to the herein problem, and other problems not mentioned herein, and aspects and features of the present disclosure that would address such problems, will be clearly understood by those skilled in the art from the description of the present disclosure herein.

In accordance with aspects of the present disclosure, there is provided an apparatus for stacking electrode plates, which includes an electrode plate movement unit configured to move the electrode plates, a slide unit having a sliding curved surface formed along its inner circumference and an electrode plate discharge port formed at its bottom, and configured to slide the electrode plates supplied from the electrode plate movement unit along the sliding curved surface for discharge through the electrode plate discharge port, and a stacking unit configured to sequentially stack the electrode plates discharged through the electrode plate discharge port.

The apparatus may further include a floating unit configured to float the electrode plates by providing wind from the bottom of the slide unit to form an air layer on the sliding curved surface.

The electrode plate movement unit may include a first electrode plate movement part configured to move a first electrode plate, and a second electrode plate movement part configured to move a second electrode plate.

The first electrode plate movement part and the second electrode plate movement part may move the first electrode plate and the second electrode plate respectively so that the first electrode plate and the second electrode plate are alternately and sequentially supplied to the slide unit.

The apparatus may further include a separation membrane supply unit configured to supply a separation membrane between the first electrode plate and the second electrode plate when the first electrode plate and the second electrode plate are alternately discharged through the electrode plate discharge port.

The separation membrane supply unit may insert the separation membrane in a zigzag pattern between the first electrode plate and the second electrode plate by repeating a process of moving the separation membrane over the first electrode plate after discharge of the first electrode plate and moving the separation membrane over the second electrode plate after discharge of the second electrode plate.

The electrode plate movement unit may be a conveyor belt.

The slide unit may have a semicircular cross-section.

The slide unit may have a curved cross-section whose slope becomes gentle from top to bottom.

The apparatus may further include a wing part positioned on a side of the electrode plate movement unit to support one side of each individual electrode plate moved by the electrode plate movement unit, thereby preventing the electrode plate supplied to the slide unit from being misaligned in a direction.

In accordance with aspects of the present disclosure, there is provided a method of stacking electrode plates, which includes moving the electrode plates by an electrode plate movement unit, sliding the electrode plates supplied from the electrode plate movement unit, by a slide unit having a sliding curved surface formed along its inner circumference and an electrode plate discharge port formed at its bottom, along the sliding curved surface for discharge through the electrode plate discharge port, and sequentially stacking the electrode plates discharged through the electrode plate discharge port by a stacking unit.

The method may further include floating the electrode plates by a floating unit configured to provide wind from the bottom of the slide unit to form an air layer on the sliding curved surface.

The moving electrode plates may include moving a first electrode plate by a first electrode plate movement part, and moving a second electrode plate by a second electrode plate movement part.

In the moving electrode plates, the first electrode plate and the second electrode plate may be moved and alternately and sequentially supplied to the slide unit respectively by the first electrode plate movement part and the second electrode plate movement part.

The method may further include supplying a separation membrane between the first electrode plate and the second electrode plate by a separation membrane supply unit when the first electrode plate and the second electrode plate are alternately discharged through the electrode plate discharge port.

In the supplying a separation membrane, the separation membrane may be inserted in a zigzag pattern between the first electrode plate and the second electrode plate by repeating a process of moving the separation membrane over the first electrode plate after discharge of the first electrode plate and moving the separation membrane over the second electrode plate after discharge of the second electrode plate.

In the moving electrode plates, the electrode plates may be moved via a conveyor belt.

In the sliding the electrode plates, the slide unit may have a semicircular cross-section.

In the sliding the electrode plates, the slide unit may have a curved cross-section whose slope becomes gentle from top to bottom.

The method may further include supporting, by a wing part positioned on a side of the electrode plate movement unit, one side of each individual electrode plate moved by the electrode plate movement unit, thereby preventing the electrode plate supplied to the slide unit from being misaligned in a direction.

### BRIEF DESCRIPTION OF THE DRAWINGS

The following accompanying drawings illustrate preferred embodiments of the present disclosure, and serve to further describe aspects and features of the present disclosure together with the detailed description of the present disclosure. Thus, the present disclosure should not be construed as being limited to the drawings, in which:

FIG. 1A is a top perspective view of a prismatic secondary battery;

FIG. 1B is a cross-sectional view taken along line I-I′ of FIG. 1A;

FIG. 2 is a top view illustrating an apparatus for stacking electrode plates according to embodiments of the present disclosure;

FIG. 3 is a side view illustrating the apparatus for stacking electrode plates according to embodiments of the present disclosure;

FIG. 4 is a perspective view illustrating a stack of electrode plates stacked by the apparatus for stacking electrode plates according to embodiments of the present disclosure;

FIG. 5 is a view illustrating an apparatus for stacking electrode plates according to embodiments of the present disclosure;

FIG. 6 is a side view illustrating a stack of electrode plates stacked by the apparatus for stacking electrode plates according to embodiments of the present disclosure;

FIG. 7 is a view illustrating another exemplary slide unit of the apparatus for stacking electrode plates according to embodiments of the present disclosure;

FIG. 8 is a view illustrating another exemplary electrode plate movement unit of the apparatus for stacking electrode plates according to embodiments of the present disclosure; and FIG. 9 is a flowchart for explaining a method of stacking electrode plates according to embodiments of the present disclosure.

### DETAILED DESCRIPTION

Exemplary embodiments of the present disclosure will be described herein in detail with reference to the accompanying drawings. Prior to the description, it is noted that the terms or words used in this specification and claims should not be construed as being limited to common or dictionary meanings but instead should be understood to have meanings and concepts in agreement with the spirit of the present disclosure based on the principle that an inventor can define the concept of each term suitably in order to describe his/her own disclosure in the best way possible. Accordingly, since embodiments described in this specification and the configurations illustrated in the drawings are only an example of the present disclosure and they do not cover all the technical ideas of the present disclosure, it should be understood that various changes and modifications may be made at the time of filing this application.

It will be further understood that the terms “comprises/includes” and/or “comprising/including” when used herein, specify the presence of stated features, integers, steps, operations, elements, components, and/or groups thereof, but do not preclude the presence or addition of one or more other features, integers, steps, operations, elements, components, and/or groups thereof.

In order to facilitate understanding of the present disclosure, the accompanying drawings are not drawn to scale and the dimensions of some components may be exaggerated. It should be noted that the same reference numerals are designated to the same components in different embodiments.

Reference to two compared elements, features, etc. as being “the same” means that they are “substantially the same”. Therefore, the phrase “substantially the same” may include a deviation that is considered low in the art, for example, a deviation of 5% or less. The uniformity of any parameter in a given region may mean that it is uniform from an average perspective.

Although the terms such as “first” and/or “second” are used to describe various components, these components are not limited by these terms, of course. These terms are only used to distinguish one component from another component. Thus, unless specifically stated to the contrary, a first component may be termed a second component without departing from the teachings of exemplary embodiments.

Throughout the specification, unless otherwise stated, each element may be singular or plural, Arrangement of any component “above (or below)” or “on (or under)” a component may mean that any component is disposed in contact with the upper (or lower) surface of the component, as well as that other components may be interposed between the element and any element disposed on (or under) the element.

It will be understood that, when a component is referred to as being “connected”, “coupled”, or “joined” to another component, not only can it be directly “connected”, “coupled”, or “joined” to the other element, but also can it be indirectly “connected”, “coupled”, or “joined” to the other element with other elements interposed therebetween.

As used herein, the term “and/or” includes any and all combinations of one or more of the associate listed items. The use of “may” when describing embodiments of the present disclosure relates to “one or more embodiments of the present disclosure”. Expressions such as “at least one” and “one or more” preceding a list of elements modify the entire list of elements and do not modify the individual elements in the list.

Throughout the specification, when “A and/or B” is stated, it means A, B, or A and B, unless otherwise stated. In addition, when “C to D” is stated, it means C or more and D or less, unless specifically stated to the contrary.

When the phrase such as “at least one of A, B, and C”, “at least one of A, B, or C”, “at least one selected from the group of A, B, and C”, or “at least one selected from among A, B, and C” is used to designate a list of elements A, B, and C, the phrase may refer to any and all suitable combinations.

The term “use” may be considered synonymous with the term “utilize”. As used herein, the terms “substantially,” “about,” and similar terms are used as terms of approximation rather than as terms of degree, and are intended to account for inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, Or section. Accordingly, a first element, component, region, layer, or section discussed herein may be termed a second element, component, region, layer, or section without departing from the teachings of exemplary embodiments.

For ease of explanation in describing the relationship of one element or feature to another element(s) or feature(s) as illustrated in the drawings, spatially relative terms such as “beneath”, “below”, “lower”, “above”, and “upper” may be used herein. It will be understood that spatially relative positions are intended to encompass different directions of the device in use or operation in addition to the direction depicted in the drawings. For example, if the device in the drawings is turned over, any element described as being “below” or “beneath” another element would then be oriented “above” or “over” another element. Therefore, the term “below” may encompass both upward and downward directions.

The terminology used herein is for the purpose of describing embodiments of the present disclosure and is not intended to limit the present disclosure.

The present disclosure will be described in detail with reference to the attached drawings.

Examples of secondary batteries include a coin type, a cylindrical type, a prismatic type, and a pouch type. The present disclosure is basically applicable to a prismatic secondary battery. Therefore, the prismatic secondary battery will first be briefly described prior to description of embodiments of the present disclosure.

The electrode assembly of the secondary battery is made to achieve its desired capacity by stacking notched positive and negative electrode plates and inserting a separation membrane between the positive and negative electrode plates. In this way, the apparatus for stacking electrode plates is called a stacking apparatus, where the stacking apparatus has various types of structures, such as zigzag, lamination, and drop, to shorten the time for stacking the electrode plates. However, conventional stacking apparatuses may require processes such as position recognition or alignment of electrode plates, which takes much time, and may become complex and larger in size due to the addition of components to perform these processes.

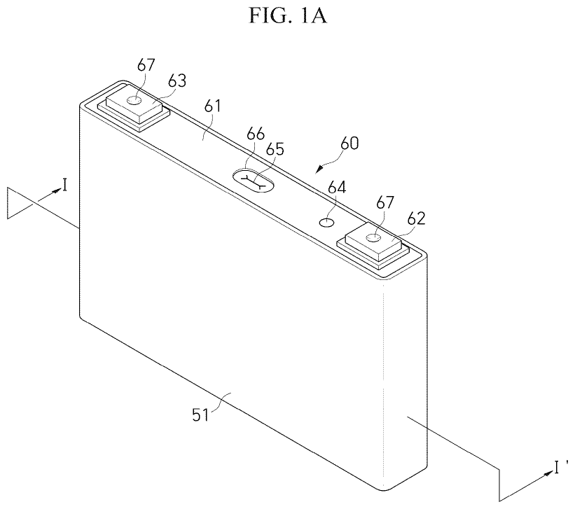

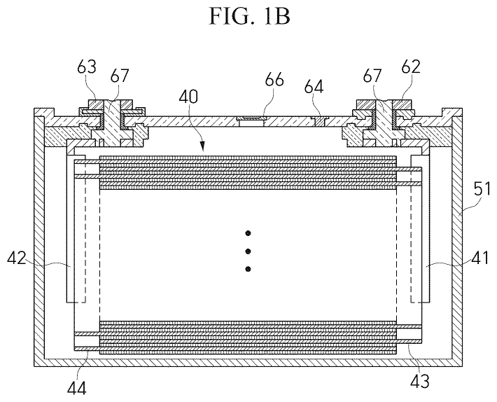

FIG. 1A is a top perspective view of the prismatic secondary battery. FIG. 1B is a cross-sectional view taken along line I-I′ of FIG. 1A.

First, the external appearance of the prismatic secondary battery illustrated in FIG. 1A will be described.

A casing 51 defines an overall appearance of the prismatic secondary battery, and may be made of conductive metal, such as aluminum, aluminum alloy, or nickel-plated steel. In addition, the casing 51 may provide a space for accommodating an electrode assembly therein.

A cap assembly 60 may include a cap plate 61 that covers the opening of the casing 51, and the cap assembly 60 and the cap plate 61 may be made of a conductive material. Here, a first terminal 63 and a second terminal 62 may be electrically connected to respective positive and negative (or negative and positive) electrodes inside the casing, and may be installed to protrude outward through the cap plate 61.

The cap plate 61 may be equipped with an electrolyte injection port 64 formed to install a sealing plug, and a vent 66 formed with a notch 65. The vent 66 is for degassing the secondary battery, i.e., for discharging gas generated inside the secondary battery.

With reference to FIG. 1B, the internal structure of the prismatic secondary battery and the coupling structure with the cap assembly 60 will be described.

As illustrated in FIG. 1B, the prismatic secondary battery may basically include an electrode assembly 40, a first current collector part 41, a first terminal a second current collector part 42, a second terminal 63, and a cap assembly 60.

The electrode assembly 40 may be formed by winding or stacking a laminate of a first electrode plate, a separator, and a second electrode plate, which are in the form of a plate or a film. When the electrode assembly 40 is a wound laminate, it may have a_ winding axis parallel to the longitudinal direction of the casing. The electrode assembly 40 may be of a stack type rather than a winding type, but the shape of the electrode assembly 40 is not limited in the present disclosure. In addition, the electrode assembly 40 may be a Z-stack electrode assembly in which a first electrode plate and a second electrode plate are inserted into both sides of a separator bent into a Z-stack. Furthermore, the electrode assembly 40 may consist of one or more electrode assemblies, which are stacked such that their long sides are adjacent to each other and accommodated in the casing, and the number of electrode assemblies is not limited in the present disclosure. The electrode assembly 40 may have a first electrode plate that acts as a negative electrode and a second electrode plate that acts as a positive electrode, or vice versa.

The first electrode plate may be formed by applying a first electrode active material, such as graphite or carbon, to a first electrode current collector plate made of metal foil, such as copper, copper alloy, nickel, or nickel alloy. The first electrode plate may include a first electrode tab (or first uncoated part) 43, which is a region without application of the first electrode active material. The first electrode tab 43 may act as a current flow passage between the first electrode plate and the first current collector part 41. In some examples, the first electrode tab 43 may be formed by cutting the first electrode plate to protrude to one side in advance when manufacturing the first electrode plate, and may protrude further to one side than the separator without separate cutting.

The second electrode plate may be formed by applying a second electrode active material such as transition metal oxide to a substrate made of metal foil, such as aluminum or aluminum alloy. The second electrode plate may include a second electrode tab (or second uncoated part) 44, which is a region without application of the second electrode active material. The second electrode tab 44 may act as a current flow passage between the second electrode plate and the second current collector part 42. In some examples, the second electrode tab 44 may be formed by cutting the second electrode plate to protrude to the other side in advance when manufacturing the second electrode plate, and may protrude further to the other side than the separator without separate cutting.

In some embodiments, the first electrode tab 43 may be located on the right end side of the electrode assembly 40, and the second electrode tab 44 may be located on the left end side of the electrode assembly 40. Alternatively, the first electrode tab 43 and the second electrode tab 44 may be located on one end side of the electrode assembly 40 in the same direction. Here, the left and the right are represented based on the secondary battery illustrated in FIG. 1 for convenience of explanation, and they may change in position when the secondary battery is rotated left and right or up and down.

The separator functions to prevent a short circuit between the first electrode plate and the second electrode plate while permitting migration of lithium ions therebetween. The separator may be made of, for example, a polyethylene film, a polypropylene film, a polyethylene-polypropylene film, or the like.

The first electrode tab 43 of the first electrode plate and the second electrode tab 44 of the second electrode plate extend from both ends of the electrode assembly 40 as described herein, respectively. In some embodiments, the electrode assembly 40 may be accommodated together with an electrolyte in the casing 51.

In the electrode assembly 40, the first current collector part 41 and the second current collector part 42 may be welded and connected to the first electrode tab 43 extending from the first electrode plate and the second electrode tab 44 extending from the second electrode plate, respectively.

The first current collector part 41 and the second current collector part 42 are connected to the first terminal 62 and the second terminal 63, as described with reference to FIG. 1A, through terminal pins 67, respectively. In some embodiments, the terminal pins 67 may each have an outer peripheral surface that is threaded, and may be fastened to the first terminal 62 and the second terminal 63 by screwing. However, the present disclosure is not limited thereto. For example, the terminal pins 67 may also be coupled to the first terminal 62 and the second terminal 63 by riveting or welding.

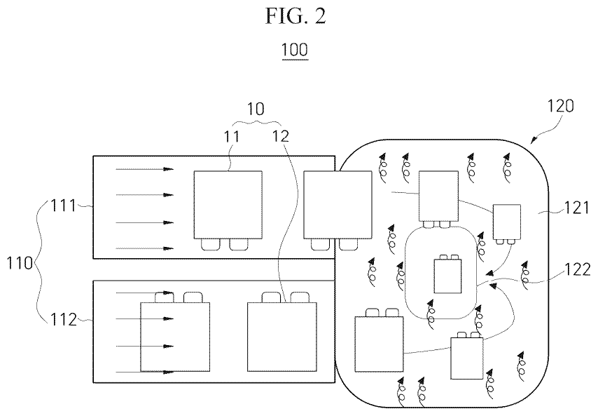

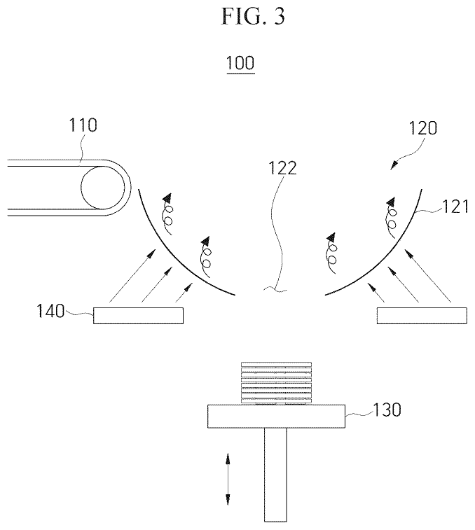

FIG. 2 is a top view illustrating an apparatus for stacking electrode plates according to embodiments of the present disclosure. FIG. 3 is a side view illustrating the apparatus for stacking electrode plates according to embodiments of the present disclosure.

Referring to FIGS. 2 and 3, the apparatus for stacking electrode plates, which is designated by reference numeral 100, according to embodiments of the present disclosure may include an electrode plate movement unit 110, a slide unit 120, a stacking unit 130, and a floating unit 140.

The electrode plate movement unit 110 moves electrode plates 10. In embodiments, the electrode plate movement unit 110 may be a conveyor belt.

The electrode plate movement unit 110 may include a first electrode plate movement part 111 to move a first electrode plate 11 and a second electrode plate movement part 112 to move a second electrode plate 12. The first electrode plate 11 and the second electrode plate 12 may be electrode plates with different polarities. For example, the first electrode plate 11 may be a positive electrode plate and the second electrode plate 12 may be a negative electrode plate, or vice versa.

In a stack of electrode plates, it is necessary to position the electrode plates with the same polarity in the same direction and to position the electrode plates with different polarities in different directions. Therefore, the first electrode plate 11 and the second electrode plate 12 may be moved in opposite directions by the first electrode plate movement part 111 and the second electrode plate movement part 112, respectively. For example, as illustrated in FIG. 2, the first electrode plate 11 and the second electrode plate 12 may be moved by the first electrode plate movement part 111 and the second electrode plate movement part 112 with electrodes pointing in a direction facing each other.

Since the stack of electrode plates also needs to be configured to alternately stack electrode plates with different polarities, the first electrode plate movement part 111 and the second electrode plate movement part 112 move the first electrode plate 11 and the second electrode plate 12 so that the first electrode plate 11 and the second electrode plate 12 are alternately and sequentially supplied to the slide unit 120.

The slide unit 120 has a sliding curved surface 121 formed along the inner circumference thereof and an electrode plate discharge port 122 formed at the bottom thereof, that the electrode plates 10 are supplied from the electrode plate movement unit 110 and slide along the sliding curved surface 121 for discharge through the electrode plate discharge port 122. In embodiments, the slide unit 120 may have a semicircular cross-section. Accordingly, the first electrode plate 11 and the second electrode plate 12 may be alternately and sequentially discharged through the electrode plate discharge port 122 by sliding in the direction of the arrow in FIG. 2.

The stacking unit 130 sequentially stacks the electrode plates 10 discharged through the electrode plate discharge port 122. In embodiments, the stacking unit 130 may stack the first electrode plate 11 and the second electrode plate 12 which are alternately and sequentially discharged through the electrode plate discharge port 122. The stacking unit 130 may move up and down to minimize damage caused by the fall of the electrode plates 10 discharged through the electrode plate discharge port 122.

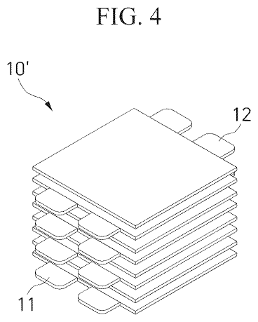

FIG. 4 is a perspective view illustrating the stack of electrode plates stacked by the apparatus for stacking electrode plates according to embodiments of the present disclosure.

It can be seen from FIG. 4 that the stack of electrode plates, which is designated by reference numeral 10′, stacked by the apparatus for stacking electrode plates according to embodiments of the present disclosure is made by alternately and sequentially stacking the first and second electrode plates 11 and 12 positioned in different directions.

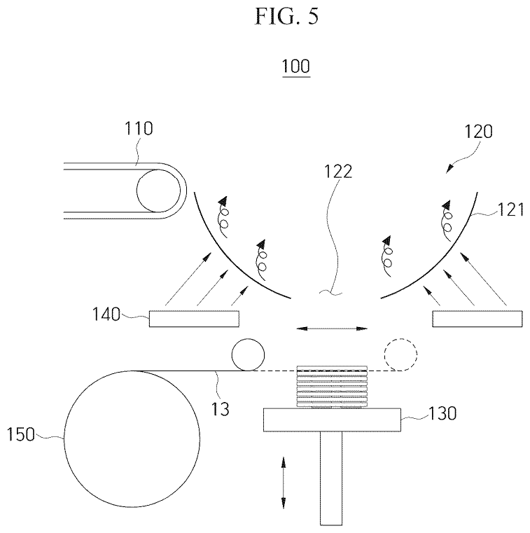

FIG. 5 is a view illustrating an apparatus for stacking electrode plates according to embodiments of the present disclosure.

Referring to FIG. 5, the apparatus for stacking electrode plates, which is designated by reference numeral 100, according to embodiments of the present disclosure may include an electrode plate movement unit 110, a slide unit 120, a stacking unit 130, a floating unit 140, and a separation membrane supply unit 150.

Since the electrode plate movement unit 110, the slide unit 120, the stacking unit 130, and the floating unit 140 are identical to those described in FIGS. 2 and 3, a description thereof will be omitted.

The separation membrane supply unit 150 supplies a separation membrane 13 between the first electrode plate 11 and the second electrode plate 12 when the first electrode plate 11 and the second electrode plate 12 are alternately discharged through the electrode plate discharge port 122. In embodiments, the separation membrane supply unit 150 inserts the separation membrane 13 in a zigzag pattern between the first electrode plate 11 and the second electrode plate 12 by repeating a process of moving the separation membrane 13 over the first electrode plate 11 after discharge of the first electrode plate 11 and moving the separation membrane 13 over the second electrode plate 12 after discharge of the second electrode plate 12. For example, the separation membrane supply unit 150 may be composed of a roll with a separation membrane wound thereon, and a roll moving from side to side to supply the separation membrane 13 between the first electrode plate 11 and the second electrode plate 12 from the roll with the separation membrane wound thereon.

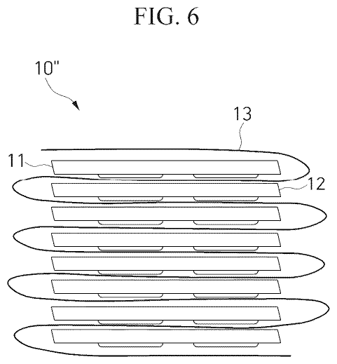

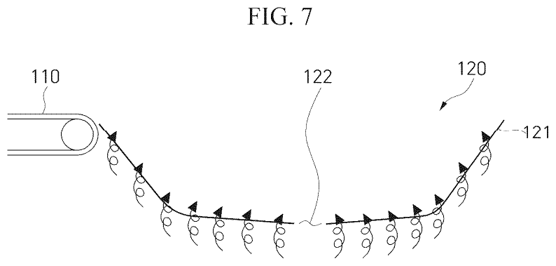

FIG. 6 is a side view illustrating a stack of electrode plates stacked by the apparatus for stacking electrode plates according to embodiments of the present disclosure.

It can be seen from FIG. 6 that the stack of electrode plates, which is designated by reference numeral 10″, stacked by the apparatus for stacking electrode plates according to embodiments of the present disclosure described in FIG. 5 is made by inserting the separation membrane 13 in a zigzag pattern between the first electrode plate 11 and the second electrode plate 12 when the first and second electrode plates 11 and 12 positioned in different directions are stacked alternately and sequentially.

The stack of electrode plates 10′may be made only by sequentially stacking the first electrode plate 11 and the second electrode plate 12 as illustrated in FIG. 4, since no separation membrane is required for semi-solid or all-solid secondary batteries. However, the stack of electrode plates 10″ may be made by inserting the separation membrane 13 in a zigzag pattern between the first electrode plate 11 and the second electrode plate 12 as illustrated in FIG. 6, since the separation membrane 13 must be inserted between the first electrode plate 11 and the second electrode plate 12 in the case of general lithium secondary batteries.

FIG. 7 is a view illustrating another exemplary slide unit of the apparatus for stacking electrode plates according to embodiments of the present disclosure, Referring to FIG. 7, another exemplary slide unit 120 of the apparatus for stacking electrode plates according to embodiments of the present disclosure may have a curved cross-section whose slope becomes gentle from top to bottom, unlike the slide unit 120 having a semicircular cross-section as illustrated in FIG. 2. Accordingly, the electrode plates 10 may move at high speed at the top of the slide unit 120 having a high initial slope, whereas the electrode plates 10 may be slowed down at the bottom of the slide unit 120 having a gentle slope before discharge through the electrode plate discharge port 122, thereby preventing damage due to impact as well as maintaining the directions of the electrode plates 10 without misalignment.

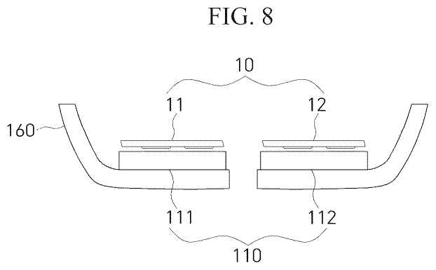

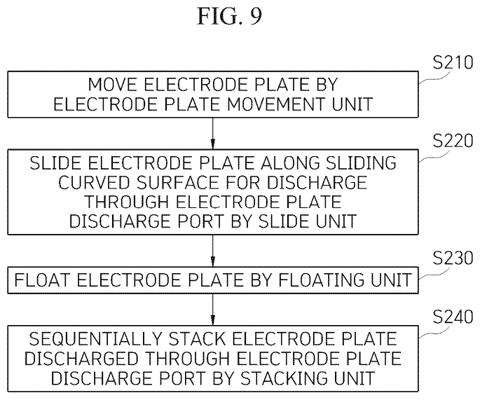

FIG. 8 is a view illustrating another exemplary electrode plate movement unit of the apparatus for stacking electrode plates according to embodiments of the present disclosure.

Referring to FIG. 8, another exemplary electrode plate movement unit 110 of the apparatus for stacking electrode plates 100 according to embodiments of the present disclosure may further include a wing part 160 positioned on the side thereof to support one side of each individual electrode plate 10 moved by the electrode plate movement unit 110, thereby preventing the direction of the electrode plate 10 supplied to the slide unit 120 from being misaligned. The wing part 160 may support one side of the electrode plate 10 when the electrode plate 10 is supplied to the slide unit 120 and floated by the floating unit 140, thereby preventing the direction of the electrode plate 10 from being misaligned.

FIG. 9 is a flowchart for explaining a method of stacking electrode plates according to embodiments of the present disclosure.

Referring to FIG. 9, the method of stacking electrode plates according to embodiments of the present disclosure may include steps S210 to S240.

Step S210 is a step of moving electrode plates by an electrode plate movement unit. In embodiments, step S210 may include a step of moving a first electrode plate by a first electrode plate movement part and a step of moving a second electrode plate by a second electrode plate movement part. In step S210, the first and second electrode plates are moved and alternately and sequentially supplied to a slide unit by the first electrode plate movement part and the second electrode plate movement part.

Step S220 is a step of sliding the electrode plates supplied from the electrode plate movement unit, by a slide unit having a sliding curved surface formed along the inner circumference thereof and an electrode plate discharge port formed at the bottom thereof, along the sliding curved surface for discharge through the electrode plate discharge port.

Step S230 is a step of floating the electrode plates by a floating unit providing wind from the bottom of the slide unit to form an air layer on the sliding curved surface.

Step S240 is a step of sequentially stacking the electrode plates discharged through the electrode plate discharge port by a stacking unit.

In embodiments, the method of stacking electrode plates according to embodiments of the present disclosure may further include a step of supplying a separation membrane between the first electrode plate and the second electrode plate by a separation membrane supply unit when the first electrode plate and the second electrode plate are alternately discharged through the electrode plate discharge port, In embodiments, in the step of supplying a separation membrane, the separation membrane is inserted in a zigzag pattern between the first electrode plate and the second electrode plate by repeating a process of moving the separation membrane over the first electrode plate after discharge of the first electrode plate and moving the separation membrane over the second electrode plate after discharge of the second electrode plate.

In embodiments, the method of stacking electrode plates according to embodiments of the present disclosure may further include a step of supporting, by a wing part positioned on the side of the electrode plate movement unit, one side of each individual electrode plate moved by the electrode plate movement unit, thereby preventing the direction of the electrode plate supplied to the slide unit from being misaligned.

The method of stacking electrode plates according to embodiments of the present disclosure has been described herein with reference to the flowchart presented in the drawing. For the purposes of simplicity, the method has been illustrated and described as a series of blocks, but the present disclosure is not limited to the order of the blocks. In addition, some blocks may occur in a different order or concurrently with other blocks than illustrated and described herein, and various different branches, flow paths, and sequences of blocks may be implemented that achieve the same or Similar results. Furthermore, all of the blocks illustrated may not be required to implement the method described herein.

Meanwhile, in the description with reference to FIG. 9, each step may be further divided into additional steps or combined into fewer steps, depending on the implementation of the present disclosure. Additionally, if necessary, some steps may be omitted or the order between steps may be changed. Moreover, even if there are any other omitted, the contents of FIGS. 1A to 8 may be applied to the contents of FIG. 9. On the other hands, the contents of FIG. 9 may be applied to the contents of FIGS. 1A to 8.

Hereinafter, materials which may be used in a secondary battery according to embodiments of the present disclosure are described.

A compound (e.g., a lithiated intercalation compound) capable of reversible intercalation and deintercalation of lithium may be used as a positive electrode active material. Specifically, one type or more selected among complex oxides of metal, selected among cobalt, manganese, nickel, and a combination of them, and lithium may be used as the positive electrode active material.

The complex oxide may be lithium transition metal complex oxide. A detailed example of the complex oxide may include lithium nickel-based oxide, lithium cobalt-based oxide, lithium manganese-based oxide, a lithium ferrous phosphate-based compound, cobalt-free nickel-manganese-based oxide, or a combination of them.

For example, a compound that is represented as one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e'0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMm_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃(0≤f≤2); and LiₐFePO₄ (0.90≤a≤1.8).

In the chemical formula, A may be Ni, Co, Mn, or a combination of them. X may be Al, Ni, Co, Mn, Cr, Fe, Mg, Sr, V, a rare earth element, or a combination of them; D may be O, F, S, P, or a combination of them. G may be Al, Cr, Mn, Fe, Mg, La, Ce, Sr, V, or a combination of them. L¹ may be Mn, Al, or a combination of them.

A positive electrode for a lithium secondary battery may include a current collector and a positive electrode active material layer formed on the current collector, The positive electrode active material layer may include the positive electrode active material, and may further include a binder and/or a conductive material.

Content of the positive electrode active material may be 90 wt. % to 99.5 wt. % with respect to the positive electrode active material layer 100 wt. %. Content of the binder and the conductive material may be 0.5 wt. % to 5 wt. % with respect to the positive electrode active material layer 100 wt. %.

Al may be used as the current collector, but the present disclosure may not be limited thereto.

A negative electrode active material may include a material capable of reversibly intercalation/de-intercalation with respect to lithium ions, lithium metal, an alloy of lithium metal, a material capable of doping and dedoping with respect to lithium, or transition metal oxide.

The material capable of reversibly intercalation/de-intercalation with respect to lithium ions may include a carbon-based negative electrode active material, for example, crystalline carbon, amorphous carbon, or a combination of them. An example of the crystalline carbon may include graphite, such as natural graphite or synthetic graphite. Examples of the amorphous carbon may include soft or hard carbon, mesophase pitch carbide, and fired coke.

An Si-based negative electrode active material or an Sn-based negative electrode active material may be used as the material capable of doping and dedoping with respect to lithium. The Si-based negative electrode active material may be silicon, a silicon-carbon composite, SiOₓ (0<x<2), a Si-based alloy, or a combination of them.

The silicon-carbon composite may be a composite of silicon and amorphous carbon. According to an implementation example, the silicon-carbon composite may include silicon particles, and may have a form in which amorphous carbon has been coated on surfaces of silicon particles.

The silicon-carbon composite may further include crystalline carbon. For example, the silicon-carbon composite may include a core including crystalline carbon and silicon particles, and an amorphous carbon coating layer disposed on a surface of the core.

A negative electrode for a lithium secondary battery may include a current collector and a negative electrode active material layer disposed on the current collector. The negative electrode active material layer may include the negative electrode active material, and may further include a binder and/or a conductive material.

For example the negative electrode active material layer may include the negative electrode active material of 90 wt. % to 99 wt. 8, the binder of 0.5 wt. % to 5 wt. %, and the conductive material of 0 wt. % to 5 wt. %.

A nonaqueous-based binder, an aqueous-based binder, a dry binder, or a combination of them may be used as the binder. If the aqueous-based binder is used as a binder for the negative electrode, the binder for the negative electrode may further include a cellulose-series compound capable of assigning viscosity.

One selected among nickel foil, stainless steel foil, titanium foil, nickel foam, copper foam, a polymer base on which a conductive metal has been coated, and a combination of them may be used as a current collector for the negative electrode.

An electrolyte for a lithium secondary battery may include a nonaqueous organic solvent and lithium salts.

The nonaqueous organic solvent may play a role as a medium through which ions that are involved in an electrochemical reaction of a battery can move.

The nonaqueous organic solvent may be a carbonate-based, ester-based, ether-based, ketone-based, or alcohol-based solvent, an aprotic solvent, or a combination of them. The carbonate-based, ester-based, ether-based, ketone-based, or alcohol-based solvent, or the aprotic solvent may be used solely, or two types or more of them may be mixed and used as the nonaqueous organic solvent.

Furthermore, if the carbonate-based solvent is used, annular carbonate and chain carbonate may be mixed and used.

A separator may be present between the positive electrode and the negative electrode depending on the type of lithium secondary battery. Polyethylene, polypropylene, and polyvinylidene fluoride, or a multi-layer having two or more layers of them may be used as the separator.

The separator may include a porous base, and a coating layer including an organic matter, an inorganic matter, or a combination of them that is disposed on one or both sides of the porous base.

The organic matter may include a polyvinylidene fluoride-based heavy antibody or (meth) acrylic polymer.

The inorganic matter may include inorganic particles selected among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination of them, but the present disclosure is not limited thereto.

The organic matter and the inorganic matter may have a form in which the organic matter and the inorganic matter have been mixed in one coating layer or a form in which a coating layer including the organic matter and a coating layer including the inorganic matter have been stacked.

As is apparent from the herein description, according to embodiments of the present disclosure, it is possible to increase spatial utilization by simplifying the configuration of the apparatus for stacking electrode plates and minimizing the size thereof since the electrode plates are slid and sequentially stacked by the slide unit having the sliding curved surface formed along the inner circumference thereof.

According to the embodiments of the present disclosure, it is possible to stack the electrode plates at high speed while minimizing damage to the electrode plates since the electrode plates are floated by providing wind from the bottom of the slide unit to form the air layer on the sliding curved surface.

However, aspects and features of the present disclosure are not limited to those described herein, and other aspects and features not mentioned will be clearly understood by a person skilled in the art from the detailed description, described herein.

Although the present disclosure has been described herein in connection with the limited embodiments and drawings, the present disclosure is not limited to the embodiments. A person having ordinary knowledge in the art to which the present disclosure pertains may modify and change the present disclosure within the technical spirit of the present disclosure and the equivalent range of the following claims.

What is claimed is:

1. An apparatus for stacking electrode plates, comprising:
an electrode plate movement unit configured to move the electrode plates;
a slide unit having a sliding curved surface formed along its inner circumference and an electrode plate discharge port formed at its bottom, and configured to slide the electrode plates supplied from the electrode plate movement unit along the sliding curved surface for discharge through the electrode plate discharge port; and
a stacking unit configured to sequentially stack the electrode plates discharged through the electrode plate discharge port.

2. The apparatus as claimed in claim 1, further comprising a floating unit configured to float the electrode plates by providing wind from the bottom of the slide unit to form an air layer on the sliding curved surface.

3. The apparatus as claimed in claim 1, wherein the electrode plate movement unit comprises:
a first electrode plate movement part configured to move a first electrode plate; and
a second electrode plate movement part configured to move a second electrode plate.

4. The apparatus as claimed in claim 3, wherein the first electrode plate movement part and the second electrode plate movement part move the first electrode plate and the second electrode plate respectively so that the first electrode plate and the second electrode plate are alternately and sequentially supplied to the slide unit.

5. The apparatus as claimed in claim 4, further comprising a separation membrane supply unit configured to supply a separation membrane between the first electrode plate and the second electrode plate when the first electrode plate and the second electrode plate are alternately discharged through the electrode plate discharge port.

6. The apparatus as claimed in claim 5, wherein the separation membrane supply unit inserts the separation membrane in a zigzag pattern between the first electrode plate and the second electrode plate by repeating a process of moving the separation membrane over the first electrode plate after discharge of the first electrode plate and moving the separation membrane over the second electrode plate after discharge of the second electrode plate.

7. The apparatus as claimed in claim 1, wherein the electrode plate movement unit is a conveyor belt.

8. The apparatus as claimed in claim 1, wherein the slide unit has a semicircular cross-section.

9. The apparatus as claimed in claim 1, wherein the slide unit has a curved cross-section whose slope becomes gentle from top to bottom.

10. The apparatus as claimed in claim 1, further comprising a wing part positioned on a side of the electrode plate movement unit to support one side of each individual electrode plate moved by the electrode plate movement unit, thereby preventing the electrode plate supplied to the slide unit from being misaligned in a direction.

11. A method of stacking electrode plates, comprising:
moving the electrode plates by an electrode plate movement unit;
sliding the electrode plates supplied from the electrode plate movement unit, by a slide unit having a sliding curved surface formed along its inner circumference and an electrode plate discharge port formed at its bottom, along the sliding curved surface for discharge through the electrode plate discharge port; and
sequentially stacking the electrode plates discharged through the electrode plate discharge port by a stacking unit.

12. The method as claimed in claim 11, further comprising floating the electrode plates by a floating unit configured to provide wind from the bottom of the slide unit to form an air layer on the sliding curved surface.

13. The method as claimed in claim 11, wherein the moving electrode plates comprises:
moving a first electrode plate by a first electrode plate movement part; and
moving a second electrode plate by a second electrode plate movement part.

14. The method as claimed in claim 13, wherein in the moving electrode plates, the first electrode plate and the second electrode plate are moved and alternately and sequentially supplied to the slide unit respectively by the first electrode plate movement part and the second electrode plate movement part.

15. The method as claimed in claim 14, further comprising supplying a separation membrane between the first electrode plate and the second electrode plate by a separation membrane supply unit when the first electrode plate and the second electrode plate are alternately discharged through the electrode plate discharge port.

16. The method as claimed in claim 15, wherein in the supplying a separation membrane, the separation membrane is inserted in a zigzag pattern between the first electrode plate and the second electrode plate by repeating a process of moving the separation membrane over the first electrode plate after discharge of the first electrode plate and moving the separation membrane over the second electrode plate after discharge of the second electrode plate.

17. The method as claimed in claim 11, wherein in the moving electrode plates, the electrode plates are moved via a conveyor belt.

18. The method as claimed in claim 11, wherein in the sliding the electrode plates, the slide unit has a semicircular cross-section.

19. The method as claimed in claim 11, wherein in the sliding the electrode plates, the slide unit has a curved cross-section whose slope becomes gentle from top to bottom.

20. The method as claimed in claim 11, further comprising supporting, by a wing part positioned a side of the electrode plate movement unit, one side of each individual electrode plate moved by the electrode plate movement unit, thereby preventing the electrode plate supplied to the slide unit from being misaligned in a direction.
